(19) United States
(12) Patent Application Publication
(10) Pub. No.: US 2008/0111419 A1
(43) Pub. Date: May 15, 2008

(54) Wheel spoke trim assembly

(76) Inventors: Alwin J. Stahel, St.Paul, MN (US); Brian K. Stahel, St.Paul, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/598,988

(22) Filed: Nov. 14, 2006

(51) Int. Cl. B60B 7/06

(52) U.S. Cl. 301/37.41

(57) ABSTRACT

A wheel spoke trim piece for attachment to a spoke and a curved rim portion of a wheel includes a first end opposite a second end, and inner and outer surfaces that extend between the first and second ends. The inner surface is generally planar but curves to form a curved portion adjacent to the second end of the trim piece. In this regard, the inner surface is configured to accept a double-sided adhesive material that permits the trim piece to be mounted on a wheel spoke with the curved portion of the trim piece positioned along at least a portion of the curved rim portion of the wheel. A textured surface region may also be formed in the outer surface between the first and second ends.

### BACKGROUND

The present invention generally relates to custom accessories for a motor vehicle, such as a motorcycle. In particular, the present invention relates to a trim piece accessory for a motorcycle wheel.

Consumers have shown a strong interest in customizing their motorcycles by adding accessories to enhance the appearance of the motorcycle. One such accessory made to be carried by the front end of a motorcycle is ring of lights adjacent to the front wheel. Another accessory known to cooperate with the ring of lights is a chromed wheel spoke accent piece. Connection of the known wheel spoke accent piece requires that holes be drilled through the wheel spokes. Bolts are then used to secure the accent piece to the wheel spoke. There is an ongoing desire to improve the appearance of wheel spoke trim accessories.

### SUMMARY OF THE INVENTION

One aspect of the present invention provides a wheel spoke trim assembly for attachment to a wheel having a plurality of spokes, where each spoke extends a spoke length between a hub and a rim of the wheel. The trim assembly includes a panel and an adhesive material configured to attach the panel to a spoke of the wheel. The panel includes opposing first and second ends, opposing first and second side edges, a first surface and a second surface opposite the first surface, where the second surface includes a first generally planar portion and a second curved portion connected to and extending from the first generally planar portion. The adhesive material has a first side configured for connection to the second surface and a second side configured for connection to the wheel spoke.

### BRIEF DESCRIPTION OF THE DRAWINGS

FIG. 1 is a perspective view of a front end of a motorcycle showing a typical front wheel assembly having a wheel spoke trim accessory of the present invention mounted thereon;

FIG. 2 is an exploded, perspective view of a wheel spoke trim assembly of the present invention relative to a spoke of the wheel shown in FIG. 1;

FIG. 3A is a rear view of a wheel spoke trim piece of the present invention showing one embodiment of a cavity configuration for the rear side of the trim piece;

FIG. 3B is a rear view of a wheel spoke trim piece of the present invention showing a second embodiment of a cavity configuration for the rear side of the trim piece;

FIG. 4 is a longitudinal cross-sectional view of the wheel spoke trim assembly illustrated in FIG. 2 mounted on the wheel;

FIG. 5 is a lateral cross-sectional view of the wheel spoke trim assembly and wheel of FIG. 4 taken along line 5-5; and

FIGS. 6-8 are front views of alternative embodiments of the wheel spoke trim piece of the present invention each with a different textured surface region formed on an outer surface of the trim piece.

### DETAILED DESCRIPTION

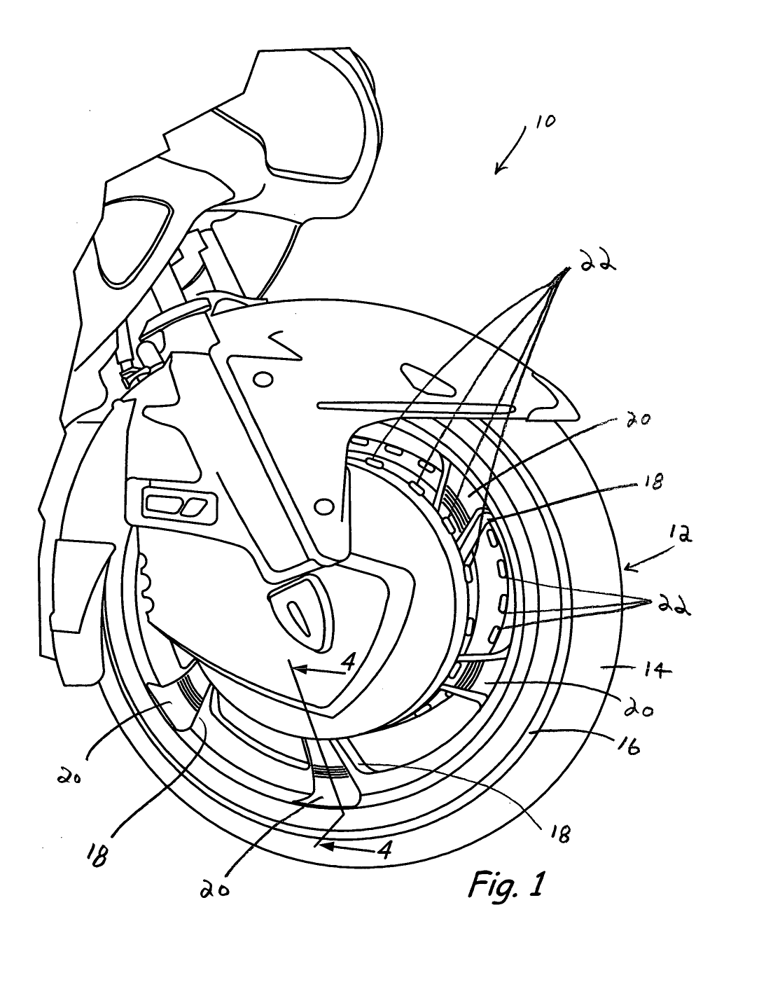

FIG. 1 is a perspective view of a motorcycle front end 10 showing a typical motorcycle front wheel assembly 12. As shown in FIG. 1, wheel assembly 12 generally comprises a tire 14 mounted on a wheel rim 16 and a plurality of wheel spokes 18 radiating from the rim 16 toward and connecting to the wheel hub (not shown). The present invention relates to an improved trim assembly 20 for mounting on the wheel spokes 18 of the wheel assembly 12. The improved trim assembly 20 of the present invention is particularly suitable for motorcycle front ends accessorized with a ring of lights 22 mounted on the motorcycle front end 10 adjacent to wheel spokes 18 of the front wheel assembly 12.

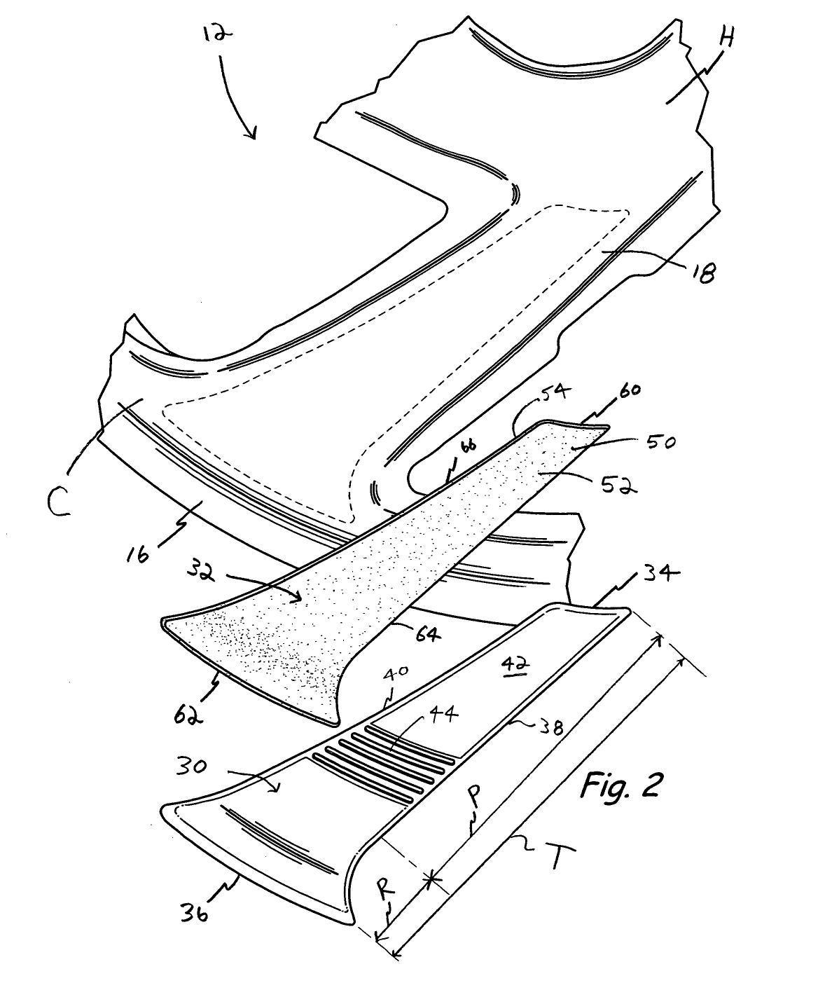

FIG. 2 is an exploded, perspective view of the wheel spoke trim assembly 20 of the present invention relative to a spoke 18 of the wheel assembly 12 shown in FIG. 1. The trim assembly 20 generally includes a panel 30 and an adhesive material 32 that attaches to the panel 30 and to the wheel spoke 18. In general, the panel 30 has a length T between a first end 34 and a second end 36 and a width defined by opposing side edges 38, 40. In one embodiment, opposing side edges 38 and 40 converge as they approach first end 34 and diverge as they approach second end 36. The particular configuration of trim assembly 20 may vary according to the particular surface shape of the wheel spoke to which the trim piece is to be applied.

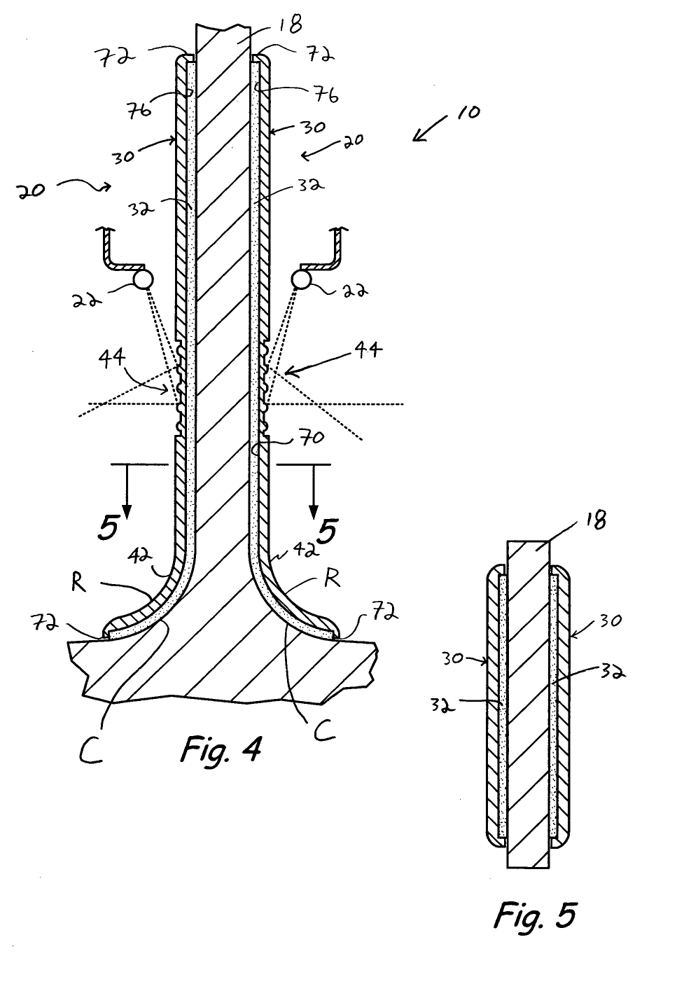

In one embodiment, the length T of the panel 30 is selected to permit the panel 30 to extend generally from the wheel hub H to at least a portion of the curved wheel side wall C forming the wheel rim 16. The panel 30 includes an upper surface 42 that generally defines an exterior of the panel 30 and a second side 70 (or inner surface) that is opposite the upper surface 42. In one embodiment, the second side 70 that forms the inner surface is configured with a relatively planar portion P that is oriented in a first plane and a radiused portion R that curves to intersect tangentially with a second plane that is different than the first plane, as best illustrated in FIG. 4 below.

With reference to FIGS. 2 and 4, in one embodiment the first plane corresponding with the planar portion P is, for example, a vertical plane, and the second plane intersecting tangentially with the radiused portion R is a horizontal plane that is substantially perpendicular to the first plane. In this manner, the second side 70 that forms the inner surface is configured to contact and couple to both the spoke 18 and the curved wheel side wall C of the rim 16. With this in mind, the exterior of the panel 30 that includes the upper surface 42 can be shaped in any suitable manner, and can include, for example, curvilinear shapes, a separate second curved radiused portion congruent to the radiused portion R, multiple faceted planes, a single planar exterior surface or any other surface suited to be formed opposite of the second side 70 that forms the inner surface. In other words, second side 70 that forms the inner surface is structured to mate with wheel assembly 12, and the exterior of the panel 30 that includes the upper surface 42 can be fashioned in any number of shapes and/or sizes to suit the design preferences of a user.

The length of planar portion P is not critical and may be sized to extend over only a portion of wheel spoke 18. The radius of curvature of the radiused portion R is selected to match the radius of curvature of the curved wheel side wall C of the wheel assembly 12. The upper surface 42 is generally visible when trim assembly 20 is mounted on the wheel spoke 18. In one embodiment, the upper surface 42 includes a textured surface region 44.

Panel 30 is preferably formed to be durable and light weight. In one embodiment, panel 30 is molded from a polymer material to have a part thickness ranging from about 0.040 inch to about 0.080 inch, and preferably the thickness of the walls of the panel 30 are about 0.060 inch. Suitable polymers for molding the panel 30 include acrylonitrile butadiene styrene (ABS), polyester, polycarbonate, fiber reinforced plastics, and the like. In one embodiment, panel 30 is molded from ABS and the upper surface 42 including the textured surface region 44 is plated with a metal, such as in chrome plating. Other plated materials, including hardened plastics and other metals are suitable for plating over the upper surface 42 and the textured surface region 44.

The textured surface region 44 is configured to interact with light, such as sunlight or light from the ring of lights 22 (FIG. 1), to provide improved visibility and aesthetics for the wheel assembly 18. In this regard, the textured surface region 44 includes reflective surfaces, such as is provided by the chrome plating described above. In other embodiments, the textured surface region 44 is formed to provide a light refracting and/or light diffusing surface that scatters incident light. To this end, in one embodiment the textured surface region 44 is formed to provide a plurality of ribs or other optically structured surface that is suited for reflecting, refracting and/or diffusing incident light.

The adhesive material 32 includes a backing 50 having a first adhesive surface 52 opposite a second adhesive surface 54 that extend between a first end 60 opposite a second end 62, and opposing side edges 64, 66. In one embodiment, the backing 50 is compliant and configured to conform to the shape of panel 30 and durably adhere to spoke 18 and the curved sidewall C (FIG. 2). Suitable backing materials for adhesive material 32 include foam backings. One suitable adhesive material is identified as Very High Bond (VHB) part No. 4941, available from 3M Company, St. Paul, Minn. Other suitable adhesive materials are also acceptable, including other 3M VHB adhesives, for example. In one embodiment, adhesive material 32 has a wall thickness ranging from about 0.040 inch to about 0.060 inch, although other thicknesses for the adhesive material 32 are also acceptable. In an alternative embodiment, the adhesive material 32 is a double-sided adhesive that does not include a compliant backing, and is thus comparatively thinner than an adhesive material provided with such a backing, having for example a thickness ranging from about 0.005 inch to about 0.030 inch. Such double-sided adhesives couple panel 30 to wheel assembly 12 (FIG. 1) without detracting from the aesthetics of the trim assembly 20.

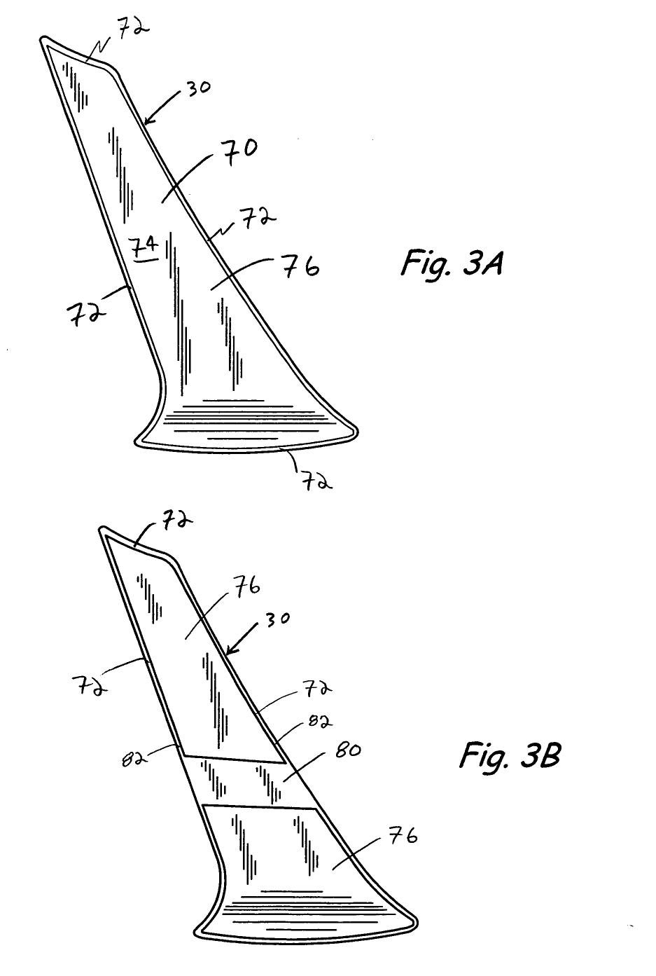

FIG. 3A is a top view of one embodiment of a second side 70 of panel 30, opposite the upper surface 42. In one embodiment, the second side 70 comprises a perimeter wall 72 which extends generally normal to a generally planar surface 74 of second side 70 so as to define a cavity 76 for receiving the adhesive material 32. The depth of cavity 76 generally ranges from about 0.040 inch to about 0.060 inch and is configured to house the adhesive material 32 out of view when the panel 30 is mounted to the wheel spoke 18. In this manner, substantially an entirety of second side 70 is configured to contact the adhesive material 32. It is to be understood that the perimeter wall 72 and the cavity 76 are not required, as a suitably thin layer of adhesive material 32 adhered to a flat second side 70 will affix the panel 30 to the wheel assembly 12 without the adhesive material 32 detracting from the appearance of the trim assembly 20.

As shown in FIG. 3B, in an alternative embodiment, cavity 76 may comprise less than the entire inner surface of the second side 70 of panel 30, such that cavity 76 is bifurcated by a panel wall 80 that is generally level with edges 82 of perimeter wall 72. In this manner, less than an entirety of second side 70 is configured to contact the adhesive material 32. Panel wall 80 and edges 82 of perimeter wall 72 are designed to lie flat against the wheel spoke 18 and curved side wall C (FIG. 2) when adhesive material 32 is positioned within cavity 76 and panel 30 is mounted the wheel assembly 18.

With additional reference to FIGS. 3A and 3B, it is to be understood that the entire second side 70 of the panel 30 need not be covered with adhesive material 32. For example, in one embodiment about one-half of the cavity 76 adjacent to the first end 34 (FIG. 2) and about one-half of the cavity 76 adjacent to the second end 36 (FIG. 2) is covered with adhesive material 32 when affixing trim assembly 20 to wheel assembly 12, although suitably more or less adhesive is also acceptable.

FIG. 4 is a longitudinal cross-sectional view of the trim assembly 20 coupled to the wheel spoke 18 according to one embodiment of the present invention, while FIG. 5 is a lateral cross-sectional view of the wheel spoke trim piece and wheel of FIG. 4 taken along line 5-5. Adhesive material 32 is positioned within cavity 76 and bonds panel 30 to the wheel spoke 18 and at least a portion of the curved wheel side wall C. Given that the thickness of adhesive material 32 is selected to approximate the depth of cavity 76, the perimeter wall 72 lies in close contact with wheel spoke 18 and curved side wall C so as to substantially hide the adhesive material 32 from view

In an alternative embodiment, the textured surface region 44 is positioned along upper surface 42 and is configured to refract, scatter and/or reflect light emanating from, for example, the ring of lights 22 mounted to the front end 10 of the motorcycle. In the embodiment shown in FIGS. 2 and 4, textured surface region 44 comprises a plurality of alternating ridges and grooves that generally extend between side edges 38 and 40 of panel 30. With additional reference to FIG. 1, during rotation of the wheel assembly 18, the ring of lights 22 is stationary relative to the moving spoke 18. In this manner, the moving spoke 18 and the textured surface region 44 are configured to refract, scatter and/or reflect light from the ring of lights 22 as the textured surface region 44 spins relative to lights 22. Naturally, the textured surface region 44 refracts, scatters and/or reflects light even when not moving, so long as incident light is available. The visibility and the aesthetics of the wheel assembly 12 are thus enhanced.

When the wheel assembly 12 (FIG. 1) is rotated, the low profile nature of the trim assembly 20 minimizes the likelihood that the panel 30 will be damaged. In particular, the trim assembly 20 of the present invention is characterized by an absence of any external connection fixtures, such as bolts, screws, clamps, and the like. In addition, during rotation, the radiused portion R of panel 30 in cooperation with the adhesive material 32 is captured by/retained against the curved side wall C by centrifugal force. That is to say, the radial acceleration of the moving wheel assembly 12 is predisposed to more firmly seat the radiused portion R of panel 30 against the curved side wall C of the wheel assembly 12.

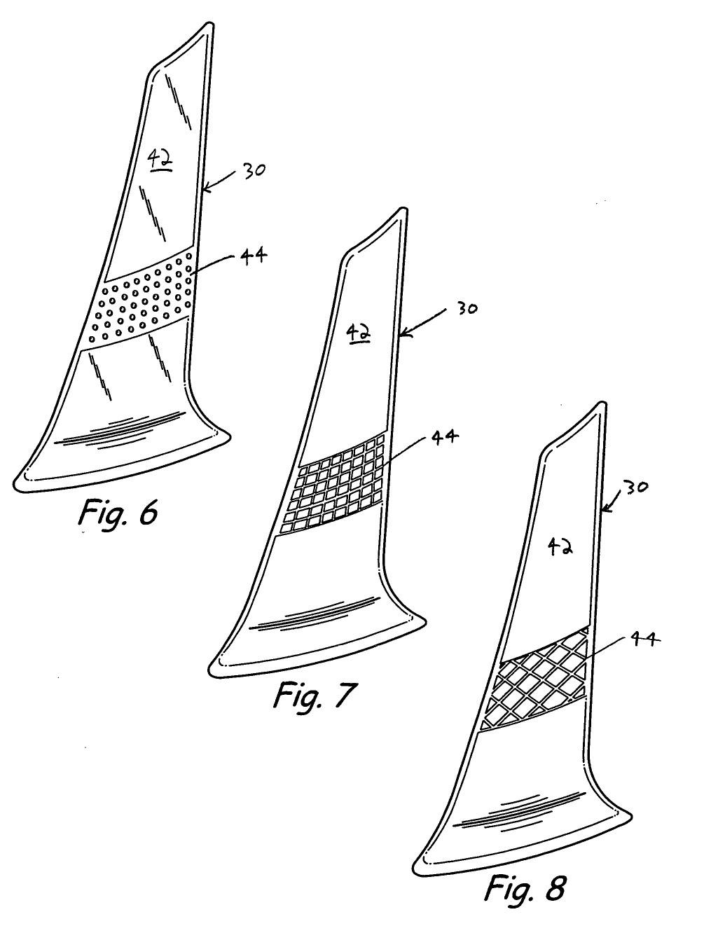

FIGS. 6-8 are front views of alternative embodiments of the wheel spoke trim assembly 20 of the present invention each with a different textured surface region 44 formed on upper surface 42 of panel 30. Other surface patterns may be used consistent with the inventive concept of placing a trim piece with some surface variation on a wheel spoke to refract, scatter and/or reflect light as the wheel assembly is rotating to enhance the appearance of the wheel assembly.

The present invention is a wheel spoke trim piece that is configured to match the shape of a wheel spoke and related portion of a curved wheel side wall of a wheel assembly. A cavity is formed on one side of the trim piece to receive an adhesive material which in turn bonds to the wheel spoke and related portion of the curved side wall without the need for any external connection fixtures, such as bolts, screws, clamps, and the like. A perimeter wall of the trim piece adjacent to the cavity hides the adhesive material. The opposite side of the trim piece is generally visible to a person viewing the wheel assembly and may include surface texturing that is configured to refract, scatter and/or reflect light as the wheel assembly is rotating to enhance the appearance of the wheel assembly.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of outer surfaces of wheel spoke trim pieces beyond the specific embodiments discussed herein. Therefore, it is intended that this invention be limited only by the claims and the equivalents thereof.

What is claimed is:

1. A wheel spoke trim assembly for attachment to a wheel having a plurality of spokes, each spoke extending a length between a hub and a rim of the wheel, the trim assembly comprising:
a panel having opposing first and second ends and opposing first and second side edges, the panel further comprising a first surface and a second surface opposite the first surface, the second surface comprising a first generally planar portion and a second curved portion connected to and extending from the first generally planar portion; and
an adhesive material having a first side configured for connection to the second surface and a second side configured for connection to the wheel spoke.

2. The trim assembly of claim 1, wherein the panel comprises a perimeter wall extending generally normal from the second surface along the first and second ends and the first and second side edges of the panel.

3. The trim assembly of claim 2, wherein the perimeter wall and the second surface combine to define a cavity.

4. The trim assembly of claim 3, wherein the cavity extends from the first generally planar portion and terminates within the second curved portion.

5. The trim assembly of claim 3, wherein the adhesive material comprises a compliant backing having a thickness that is approximately equal to a depth of the cavity.

6. The trim assembly of claim 1, wherein the second curved portion is configured to mate with a radiused sidewall of the rim of the wheel.

7. The trim assembly of claim 1, wherein the second curved portion is substantially orthogonal to the first generally planar portion.

8. The trim assembly of claim 1, wherein the first surface of the panel comprises a textured surface region disposed between the first and second ends.

9. A wheel spoke trim piece for attachment to a spoke and a rim portion of a wheel, the trim piece comprising:
a first end opposite a second end;
an outer surface extending between the first and second ends; and
an inner surface including a generally planar portion extending from the first end toward the second end and a curved portion extending from the generally planar portion to the second end, the inner surface configured to receive an adhesive material and to mate with the wheel spoke and the rim portion.

10. The trim piece of claim 9, wherein the outer surface comprises a textured surface region formed between the first and second ends.

11. The trim assembly of claim 9, wherein the inner surface comprises a perimeter wall extending generally normal from the inner surface along the first and second ends and along first and second opposing side edges of the trim piece.

12. The trim assembly of claim 11, wherein the perimeter wall and the inner surface combine to define at least one cavity.

13. The trim piece of claim 12, wherein the at least one cavity extends between the first and second ends and is configured to accept a double-sided adhesive.

14. The trim piece of claim 9, wherein the generally planar portion is oriented in a first plane and the curved portion intersects tangentially with a second plane that is different than the first plane.

15. A wheel spoke trim piece for attachment to a wheel assembly, the trim piece comprising:
a first end opposite a second end;
an outer surface extending between the first and second ends;
an inner surface including a generally planar portion extending from the first end toward the second end and a curved portion extending from the generally planar portion to the second end, the inner surface configured to receive an adhesive material and to mate with the wheel spoke and the rim portion; and
means for attaching the inner surface to a curved sidewall of a rim of the wheel assembly.

16. The trim piece of claim 15, wherein the outer surface comprises a textured surface region formed between the first and second ends.

17. The trim piece of claim 15, wherein the inner surface defines a cavity within the curved portion that is sized to receive an adhesive material configured to adhere the curved portion of the inner surface to the curved sidewall of the rim.

18. The trim piece of claim 15, wherein the means for attaching the inner surface to a curved sidewall of a rim of the wheel assembly comprises affixing the trim piece to the curved sidewall of the rim in a manner characterized by an absence of mechanical fasteners projecting from the outer surface.

19. The trim piece of claim 15, wherein the inner surface comprises a perimeter wall that defines a cavity within both of the generally planar portion and the curved portion, and wherein the means for attaching the inner surface to a curved sidewall of a rim of the wheel assembly comprises an adhesive material disposed within a portion of the cavity, the adhesive material configured to adhere the generally planar portion to a spoke and adhere the curved portion to the curved sidewall of the rim.
